(19) United States
(12) Patent Application Publication
(10) Pub. No.: US 2004/0162755 A1
(43) Pub. Date: Aug. 19, 2004

(54) Airport passenger processing and surface transportation system

(76) Inventor: Peter John Muller, Littleton, CO (US)

Correspondence Address: Peter John Muller, 960 East Cottonwood Avenue, Littleton, CO, 80121, US

(21) Appl. No.: 10/368,118

(22) Filed: Feb. 15, 2003

(51) Int. Cl. G06F 17/60

(52) U.S. Cl. 705/13

(57) ABSTRACT

A personal rapid transport system comprising guideways (20) and automated transportation pods (28) containing wireless computer communications (44) allows passengers to undertake transactions with airline, airport and security staff while traveling from intermodal centers (16) directly to aircraft boarding gates (38). The system transports checked bags to the gate and, with the possible exception of security screening, mostly eliminates the need for standing in line and walking long distances. The system issues boarding passes and baggage tags to passengers in the transportation pods, informs them of the waiting time until boarding and offers them their option of waiting areas. The system can ensure passengers arrive at boarding gates at their individually assigned boarding times thus virtually eliminating waiting at the gate. The system can inform arriving passengers when their bags are offloaded so they can deplane, immediately collect their luggage and board a transportation pod for a non-stop return trip to their originating intermodal center or destination of choice. The system can facilitate a security perimeter (24) around all public access airport buildings whereby passenger and other screening can be accomplished prior to entry to such buildings. It can also facilitate the elimination of large public transportation vehicles such as buses from the airport property thus removing a potential terrorist target. In addition, the system can eliminate the potential terrorist target presented by large groups of people waiting with unscreened baggage to be processed through ticketing and bag check-in. The system facilitates the replacement of conventional airport terminal buildings with consolidated concession facilities (26) and allows airport facilities such as runways (10) and concourses (14) to be spaced far apart.

### BACKGROUND

1. Field of Invention

This invention relates to a system and method for facilitating passenger surface transportation and processing through an airport.

### Definitions of Terms

The basic and fundamental nature of the invention discussed herein makes it desirable to carefully define certain terms, some of which are used with a special connotation as follows:

| | |
|---|---|
| T-Pod | Transportation pod consisting of a small, |
| | self-guided vehicle carrying a limited |
| | number of passengers who generally wish to |
| | travel together |
| Guideway | A pathway along which T-Pods travel |
| | guided by physical, mechanical, magnetic or |
| | other means |
| Personal Rapid | A public transit system utilizing T-Pods and |
| Transit (PRT): | guideways |
| Wayfinding: | The process of following signs and |
| | directions to reach a desired destination |
| Concourse | A facility for transferring passengers from |
| | the interior of a building to the interior of an |
| | aircraft. Usually incorporates one or more |
| | gates. |
| Gate | Portion of the concourse where boarding |
| | passes are checked and passengers move |
| | from the building into the aircraft —usually |
| | by means of a boarding bridge |
| Mode | Method of transportation such as air, car, |
| | bus, train or foot |
| Surface transportation | Transportation modes other than air |
| Intermodal center | Facility for transferring between modes of |
| | surface transportation |
| Airport | Facility for switching between surface and |
| | air modes |
| Airside | That portion of an airport accessible by |
| | aircraft |
| Terminal | A facility for processing air travelers |
| | through ticketing and security. May also |
| | incorporate concourse functions |

### BACKGROUND

2. Discussion of Prior Art

The process of transferring large numbers of the public from surface to air transportation has historically been accomplished through buildings known as terminals and concourses. These may be separate structures connected by some form of public surface transportation, or they may be contained within one building. The purpose of the terminal building is primarily to accommodate two functions—ticketing and security. The ticketing function involves selling tickets to passengers, confirming schedules, routes and seat assignments, issuing boarding passes and checking bags. The security function involves confirming the identity of boarding pass holders and screening passengers and bags for items that could be used to support a terrorist attack or aircraft hijacking. The purpose of the concourse is to provide sheltered entry to the aircraft at a location proximate to the aircraft where boarding passes can be verified and passengers can be allowed to board the aircraft in an organized manner (typically those seated at the rear are boarded first).

Processing passengers through terminals and concourses at large airports requires that the passengers spend significant amounts of time waiting in line, have to walk significant distances and have to find their way through strange buildings while carrying or dragging their luggage. To add to these issues, large unpredictable variations in processing times often result in passengers expending considerable amounts of time waiting to board at the gate. Since the gates are widely separated because of the large size of most commercial service aircraft, they are not well served by concessions. While terminal areas typically provide somewhat better concessions, passengers are often reluctant to spend time in the terminal when they are unsure of the time required to pass through security and travel to their departure gate.

Heretofore it has been assumed sufficient to limit security screening to potential passengers. This is commonly accomplished prior to entering the concourse at larger airports and prior to entering the gate area at smaller airports. This system is problematic because, not knowing how long the screening will take, passengers proceed to the concourse or gate area early and are then stuck away from the terminal area with its superior concessions. More seriously, this system does not facilitate screening of employees should this become desirable. It also allows crowds of unscreened people including passengers with their unscreened luggage, meters, greeters, employees and any member of the public to congregate in terminal buildings thus forming an obvious terrorist opportunity.

Various devices have been implemented to facilitate public surface transportation through airports. Automated people movers are designed to move large numbers of people at a time along a corridor. They are commonly used to connect terminal buildings with remote concourses. Because they are designed to carry large numbers of people, economics constrains them to routes along which large numbers of people must travel. For this reason, most people movers do not serve individual, or even small groups of gates. Significant walking distances often remain from the people mover to the gate. This situation is commonly relieved somewhat by the use of moving sidewalks.

Recognizing the difficulty of walking long distances accompanied by luggage, many airports provide small vehicles similar to golf carts for the use of the handicapped. These vehicles each have a driver and must make their way through crowds of walking passengers. Because of the high operating costs and the inefficiency of operating these vehicles amongst the pedestrian traffic, their use has been limited to serving handicapped passengers only.

Both MacDonald and Robinson et al have recognized that a PRT system could address some of the issues addressed above. They suggest that such a system could serve to transport passengers from remote parking lots to ticketing and bag check-in and then again from ticketing to remote concourses. Passengers are required to ride their system from ticketing to the gate but may use alternative means to reach ticketing. Requiring passengers to use PRT to the gate allows the construction of small, isolated concourses that can be configured to allow aircraft to power away from the gate thus eliminating the need for tugs to push the aircraft back from the gate. Their systems solve much of the problem related to long walking distances but does not change the need to wait to be processed through ticketing, security and boarding. It also results in potentially less concessions being in the concourses (because the number of gates per concourse is reduced). This is problematic because their systems do nothing to reduce time spent in the concourse.

The state of the industry and prior art teaches that commercial service aircraft passengers who wish to check bags must process through a ticketing area away from the boarding gate. From this point their checked bags are transported to the aircraft by a completely different system than they are transported by. It teaches further that, once passengers have passed though security screening they may no longer access the concessions and amenities provided in the main terminal but are limited to the generally more meager offerings to be found in the concourses. It also teaches that passengers must wait in line at ticketing, security screening and just prior to boarding the aircraft. In addition, they must spend considerable time waiting close to the boarding gate. Finally, it teaches that security screening is limited to ticketed passengers and is conducted between the terminal and the concourses.

### Objects and Advantages

Accordingly, several objects and advantages of this invention are that passengers and their bags are transported directly from remote parking areas to their gate with limited walking and no standing in line. Passengers transact all ticketing functions with airlines while in transit to the gate. This includes obtaining a boarding pass and luggage tags for the bags they wish to check. Checked bags are transported to the gate by the same means that passengers are transported.

It is a further object of my invention that passengers are processed through security prior to obtaining free access to any airport facility.

Furthermore my invention facilitates security screening of all entering the airport including employees and visitors.

It is another object of my invention to facilitate the disaggregation of airport travelers into small groups thus avoiding the potential terrorist target offered by transportation means such as buses and by large groups of people waiting with their unscreened luggage to be processed through ticketing and bag check-in areas.

It is another object of my invention to essentially eliminate waiting at the gate and thereby the need for concessions in the concourse.

It is another object of my invention that immediately upon deplaning arriving passengers are met by their bags at the gate. Returning passengers are then automatically transported back to their point of origin, commonly the place they parked their car.

It is another object of my invention to consolidate most airport passenger waiting into one block of time.

It is another object of my invention that passengers no longer need to find their way through an airport but that wayfinding be automatically accomplished by the transportation system itself.

It is another object of my invention to replace the terminal building with a consolidated concessions building.

It is yet a further object of my invention to mostly eliminate the complex baggage handling systems as are currently in use.

In summary, it is an object of my invention to provide a process for facilitating passenger travel through an airport that reduces walking, waiting and wayfinding and increases security as well as the potential productivity of any remaining waiting time.

Further objects and advantages of my invention will become apparent from a consideration of the drawings and ensuing description.

### DESCRIPTION OF DRAWINGS

FIG. 1 is a plan view of an airport depicting my airport passenger processing and surface sportation invention.

FIG. 2 is a plan view of an airport concourse depicting my airport passenger processing surface transportation invention.

FIG. 3 is a side view of a transportation pod.

List of Reference Numerals

| | |
|---|---|
| 10 | runway |
| 12 | taxiway |
| 14 | concourse |
| 16 | intermodal center |
| 20 | guideway |
| 21 | arrow depicting direction of travel |
| 22 | security screening facility |
| 24 | secure perimeter |
| 26 | consolidated concession facility |
| 28 | transportation pod |
| 30 | concourse second level |
| 32 | passenger boarding bridge |
| 34 | baggage conveyor system |
| 36 | aircraft |
| 38 | gate |
| 42 | aircraft departure path |
| 44 | wireless communication computer with |
| | microphone, speaker, video camera and device for |
| | issuing boarding passes and luggage tags |

### DESCRIPTION OF INVENTION

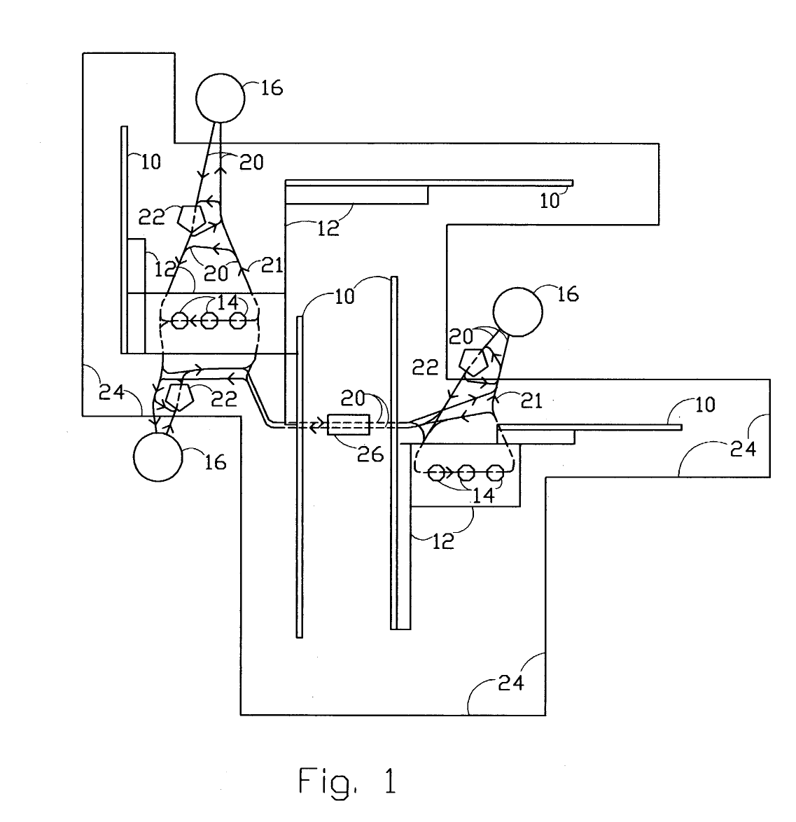

A preferred embodiment of the present invention is illustrated in FIG. 1 (top view). A plurality of runways 10 and taxiways 12 provide the airside infrastructure for a large airport serving paying passengers with scheduled flights. A plurality of concourses 14 is located in positions convenient for connection to groups of runways by means of taxiways. A plurality of intermodal centers 16 are located outside a secure perimeter 24 surrounding the runways and taxiways. A consolidated concessions facility 26 is located within the secure perimeter. The intermodal centers are connected to each other, the concourses and the consolidated concessions area by T-Pod guideways 20. T-Pod guideways pass through security screening facilities 22 prior to providing access from the intermodal centers to either the concourses or the consolidated concessions area.

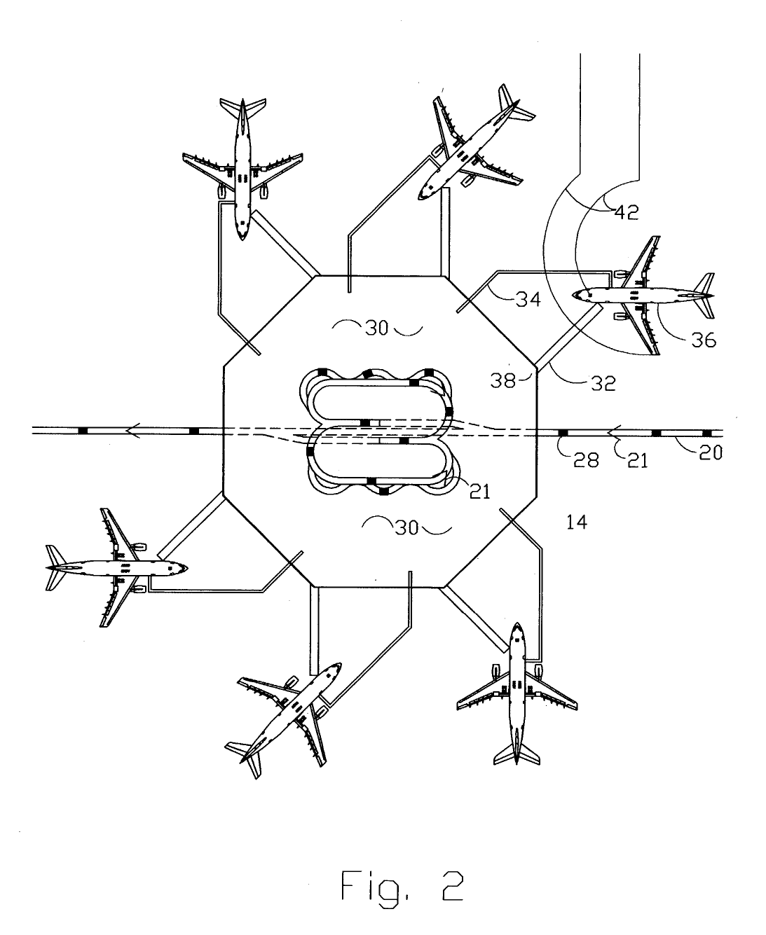

FIG. 2 is an enlarged top view of a concourse 14. The T-Pod guideway 20 enters the concourse at ground level in the preferred embodiment. It passes directly through the concourse and out the other side. This allows T-Pods not destined to this concourse to continue their journey without interruption. T-Pods destined to this concourse follow a branch guideway which carries them up to a second level 30 of the concourse. A plurality of aircraft 36 may be parked adjacent to the concourse. Passenger access to the aircraft is through a gate 38 and by means of a boarding bridge 32. Bags are loaded from the T-Pods onto the aircraft by means of a bag conveyor system 34. Portions of the bag conveyor system are movable to allow the aircraft to follow a curved departure path 42.

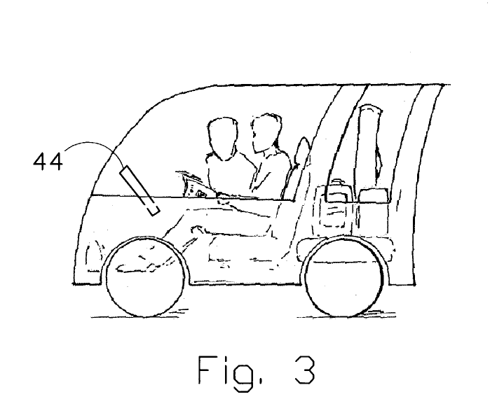

FIG. 3 is a side view of a T-Pod depicting the wireless communications computer 44 capable of issuing boarding passes and luggage tags and equipped with video camera, microphone and speaker.

### Operation of Invention

In the preferred embodiment of this invention all on-airport personnel surface transportation excepting bulk deliveries and airport-operating equipment is accomplished by PRT. PRT guideways connect perimeter intermodal facilities directly with concourses. The only required stop is to pass through a security checkpoint on the journey into the airport.

Each PRT vehicle is equipped with a touch-screen computer capable of wireless communication with the airlines, concessionaires, airport administration, security, etc. This communication is facilitated by the Internet or by an intranet. Upon entering an identification number, the computer will immediately know the destination and purpose of the trip by accessing airline ticketing information or airport employee data. In the event this data is not available for the identification number entered, the computer will interact with the passenger to determine it.

All destinations will be accessible from all intermodal facilities by two or more routes. The PRT control software will determine the most expeditious route based on current system travel times.

While traveling in the T-Pod passengers will use the computer to transact with the airline to obtain seating assignments, boarding passes and luggage tags.

While the T-Pod proceeds to the security checkpoint, the computer will interact with the passenger(s) to extract any information considered useful for potentially expediting the security screening process. The computer will be quipped with a microphone and speaker to allow audio communication with the passenger(s). It will also be equipped with a video camera(s) to facilitate the use of recognition software to verify passenger identity and possibly identify undesirable passengers.

When the T-Pod reaches the screening area it will wait its turn at a sufficient distance from other T-Pods to avoid catastrophic results should a passenger detonate a bomb prior to security screening. Until technological advances permit screening on board the T-Pod, passengers will have to exit their T-Pod and their luggage will have to be removed to facilitate the screening process, however they will wait their turn for screening in seated comfort in the T-Pod. Upon completion of security screening, the passengers and their bags will be reloaded into the T-Pod. However, the checked bags may be loaded into a secure area of the T-Pod not accessible to passengers.

Upon leaving the screening area the passenger(s) will be notified by the computer of the amount of spare time they will have prior to boarding their aircraft. They will be offered a number of alternative ways to spend this time ranging from sitting in the T-Pod at a station to visiting a specific area of the consolidated concessions building. When a T-Pod drops passengers off at concessions it will then proceed to take their checked bags to their gate. Part or all of this trip may involve carrying other passengers. The T-Pod will surrender the checked bags to airline or security employees at the gate for loading onto the aircraft.

Passengers visiting the concessions building will be automatically contacted by pager or cell phone when it is time to proceed to the gate. They will then proceed to the nearest T-Pod and enter their identification number(s) into the on-board computer. If the system provided the pager used to contact them, they will be required to return it at this time. The T-Pod will then deliver them to their gate within a few minutes of the time the airline is ready for them to board. They will then proceed directly onto the aircraft with next to no waiting.

Upon returning from their trip, passengers will wait on board the aircraft until their bags are offloaded at which time they will be asked to deplane. Passengers will thus deplane in approximately the reverse order in which their luggage was loaded. When they reach the gate their luggage will be waiting for them. They will be able to load their luggage on a T-Pod with possible assistance from airline or airport employees. Once they have entered their identification number into the on-board computer the T-Pod will remember which intermodal facility their trip originated from and take them directly back to the originating station at that facility with no further waiting or mode changes.

I have discovered that numerous unexpected advantages accrue as a result of the combination of PRT and wireless computer communication technologies and the unique arrangement of intermodal facilities, concourses, security screening facilities and guideways in my invention.

### Conclusion, Ramifications and Scope of Invention

Thus the reader will see that my invention provides a means of processing passengers though an airport that largely eliminates waiting for ticketing, bag check in, boarding and bag claim. The PRT system with wireless computer communication has additional advantages in that

It eliminates most of the mechanical bag conveyance system presently required at large airports;

It permits almost all waiting other than for security screening to be undertaken at one time;

It permits almost all waiting other than for security screening to be undertaken at a selected location;

It permits waiting for security screening to be undertaken while seated;

It largely eliminates the need for a ticketing and bag check in area;

It substantially reduces the amount of walking required;

It reduces the need for special equipment to handle handicapped passengers;

It largely eliminates the need for concessions in the concourses and permits consolidation of concessions into one area;

It permits the screening of passengers prior to their obtaining access to any airport facility;

It facilitates establishment of an airport security perimeter within which access is restricted to those who have been screened—employees and passengers alike thus reducing unscreened access to airport public buildings;

It facilitates construction of concourses that are widely separated from each other and thus the construction of runways that are remote from the remainder of the airport;

It eliminates the need for arriving passengers to stand around waiting for their checked bags to arrive;

It reduces the terrorist target offered by large transportation vehicles such as buses approaching airport facilities.

It reduces the terrorist target offered by large groups of people congregating with unscreened luggage while waiting to be processed through ticketing and bag check-in.

While my above description contains many specificities, these should not be construed as limitations on the scope of the invention, but rather as an exemplification of the presently preferred embodiment thereof. Many other variations are possible. For example a limited version of the invention could be implemented to serve only those passengers renting cars at their destination city. On their arrival they could be directed to the Rental Car PRT System. Upon entering their rental car reservation number, the T-Pod would take them directly to the remote rental car facility. If they had checked bags the PRT system would take them to the baggage claim area where they would disembark and collect their bags in the conventional way. Once they had collected their bags they would then re-enter a T-Pod to continue their journey. Passengers with no checked bags would have a non-stop journey. On the way they would transact the details of their car rental with the rental car company by means of the on-board computer. Their return trip would be the reverse with the addition of a stop at security screening and obtaining their boarding pass from the on-board computer while transacting with the airlines. Once again passengers with luggage to be checked may have to make an additional stop at ticketing to check in their luggage.

Accordingly, the scope of my invention should be determined not by the embodiments illustrated, but by the appended claims and their legal equivalents.

I claim:

1. a system and method for facilitating passenger surface transportation and processing through an airport comprising:
(a) a personal rapid transport system capable of automatically transporting passengers and their luggage comprising:
(i) a plurality of transfer means for changing modes of surface transportation;
(ii) a plurality of aircraft boarding means for changing between surface and air transportation modes
(iii) a plurality of pathways connecting said transfer means and said aircraft boarding means;
(iv) a plurality of transportation pods each capable of transporting a small plurality of said passengers and their luggage along selected portions of said pathways;
(v) guidance means to automatically direct said transportation pods along said pathways;
(b) communication means for communication between said passengers and, inter alia, airport, airline and security personnel and computer systems while traveling in said transportation pods;
whereby passenger boarding pass means for permitting said passengers access through said aircraft boarding means are issued to said passengers while traveling in said transportation pods thus eliminating processing of said passengers without checked luggage through a ticketing area and permitting travel of said passengers without checked luggage without stopping or waiting from said transfer means to said aircraft boarding means with the possible exception of waiting for security screening and whereby returning passengers without checked luggage may travel without stopping or waiting from said aircraft boarding means to said transfer means.

2. The system and method of claim 1 wherein baggage tag means for identifying bags and their destination are issued to said passengers while traveling in said transportation pods thus eliminating processing of most of said passengers through a ticketing and baggage check area and permitting travel for most of said passengers without stopping or waiting from said transfer means to said aircraft boarding means with the possible exception of waiting for security screening.

3. The system and method of claim 1 wherein said passengers are notified of expected waiting times and provided the option to choose waiting locations.

4. The system and method of claim 1 wherein said plurality of passengers in most of said transportation pods are transported to said aircraft boarding means to arrive at assigned boarding times whereby waiting in proximity to said aircraft boarding means is mostly eliminated.

5. The system and method of claim 1 wherein arriving passengers are notified of the unloading of their checked bags whereby waiting for bag unloading is accomplished while seated prior to deplaning.

6. The system and method of claim 1 further including microphone and speaker means to enhance said communication means.

7. The system and method of claim 1 further including video camera means within said transportation pods to transmit video images of the passengers.

8. The system and method of claim 7 wherein said video images are used for security purposes.

9. The system and method of claim 1 wherein airline, airport, concession and other employees and visitors utilize said system and method whereby almost all airport surface transportation excepting bulk deliveries and specialized equipment utilize said system and method.

10. The system and method of claim 1 wherein almost all security screening is undertaken at a secure perimeter encircling almost all airport public access buildings whereby unscreened access to said airport public buildings can be substantially reduced.

11. In an airport personal rapid transit system comprising a plurality of transportation pods equipped with guidance means for automatic travel and route selection, each of said transportation pods being capable of transporting a small plurality of people along chosen pathways between a plurality of transfer means for changing between modes of surface transportation and a plurality of aircraft boarding means for changing between said modes of surface transportation and air transportation modes, the improvement wherein said transportation pods contain communications means whereby said passengers can transact with airline personnel and computers to receive seating assignments and be issued passenger boarding pass means without the necessity to leave said transportation pod.

12. The system of claim 11 wherein said communications means issues baggage tag means for identifying bags and their destination thus eliminating processing of most of said passengers through a ticketing and baggage check area and permitting travel for most of said passengers without stopping or waiting from said transfer means to said aircraft boarding means with the possible exception of waiting for security screening.

13. The system of claim 11 wherein said communication means notifies said passengers of expected waiting times and provides the option to choose waiting locations.

14. The system of claim 11 wherein said plurality of passengers in most of said transportation pods are transported to said aircraft boarding means to arrive at assigned boarding times whereby waiting in proximity to said aircraft boarding means is mostly eliminated.

15. The system of claim 11 wherein arriving passengers are notified of the unloading of their checked bags whereby waiting for bag unloading is accomplished while seated prior to deplaning.

16. The system of claim 11 further including microphone and speaker means to enhance said communication means.

17. The system of claim 11 further including video camera means within said transportation pods to transmit video images of the passengers.

18. The system of claim 17 wherein said video images are used for security purposes.

19. The system of claim 11 wherein airline, airport, concession and other employees and visitors utilize said system whereby almost all airport surface transportation excepting bulk deliveries and specialized equipment utilize said system.

20. The system of claim 11 wherein almost all security screening is undertaken at a secure perimeter encircling almost all airport public access buildings whereby unscreened access to said airport public buildings can be substantially reduced.
